(19) United States
(12) Patent Application Publication
(10) Pub. No.: US 2010/0068185 A1
(43) Pub. Date: Mar. 18, 2010

(54) METHODS FOR INTRODUCING BACTERIOPHAGE INTO THE INTERIORS OF QUANTITIES OF EDIBLE AGRICULTURAL PRODUCTS AND EDIBLE AGRICULTURAL PRODUCTS WITH PHAGE-CONTAINING PREPARATIONS IN THE INTERIORS THEREOF

(75) Inventor: Justin Reber, Highland, UT (US)

Correspondence Address: TRASKBRITT, P.C., P.O. BOX 2550, SALT LAKE CITY, UT, 84110, US

(73) Assignee: OmniLytics, Incorporated, Salt Lake City, UT (US)

(21) Appl. No.: 12/212,554

(22) Filed: Sep. 17, 2008

(51) Int. Cl. A01N 63/00; A01P 1/00

(52) U.S. Cl. 424/93.6

(57) ABSTRACT

Methods for treating foods with bacteriophage include introducing, or incorporating, bacteriophage into the interiors of edible agricultural products, such as ground meats, milled grains, and other ground, cut, or processed edible agricultural products, or solid edible agricultural products. The phage, or a phage-containing preparation of which the phage is a part, may be dispersed throughout the edible agricultural product. Such dispersal may be substantially homogenous. The introduction of phage into the interior of a quantity of an edible agricultural product is useful for controlling bacterial populations in the edible agricultural product.

### FIELD OF INVENTION

The present invention relates generally to methods for treating edible agricultural products with bacteriophage. More specifically, the present invention relates to methods for incorporating bacteriophage into the interiors of edible agricultural products, such as ground meats, other ground, cut, or processed edible agricultural products, or solid edible agricultural products, to control bacterial populations therein. The present invention also relates to edible agricultural products, including, but not limited to, ground meats, other edible agricultural products that have been ground, cut, or otherwise processed, and solid edible agricultural products, throughout which bacteriophage are dispersed.

### BACKGROUND OF RELATED ART

Bacteria are typically present on or in agricultural products, including products obtained from animals and plants. The sources of such bacteria include the sources of the agricultural products themselves. In addition, despite the use of various preventative measures in environments for processing agricultural products, bacteria may contaminate agricultural products as they are processed. Such bacterial contamination may occur due to the presence of bacteria in processing environments, on personnel who process agricultural products, on equipment for processing agricultural products, on handlers of the agricultural products, or on packaging equipment or materials.

Incidences of contamination of agricultural products by bacteria, as well as the dangers of bacterially contaminated agricultural products (e.g., serious illnesses, death, etc., resulting from contaminated foods), are well publicized. In view of the risks posed by bacteria on agricultural products, a number of disinfection processes have been or are being developed in an effort to curb the spread and proliferation of harmful bacteria on agricultural products.

Many existing processes for disinfecting agricultural products, including known phage-treatment processes, merely address the outer surfaces of agricultural products that may have been exposed to and contaminated with bacteria during handling or processing. The scope of such processes, and their effectiveness, are predominantly limited to the treated parts of the agricultural products. When existing phage treatment processes are used to disinfect agricultural products, phage are primarily present at the locations to which they have been applied; i.e., only the outer surfaces of the agricultural products.

### SUMMARY

The present invention includes methods for controlling bacterial populations within edible agricultural products, including both full and partial disinfection of edible agricultural products. In various embodiments of such methods, preparations containing bacteriophage, or, for the sake of simplicity, “phage,” targeted for one or more bacteria of concern are applied to the edible agricultural products in a manner that will ultimately introduce the phage onto both exterior surfaces and internal areas of a quantity of an edible agricultural product. In some embodiments, the edible agricultural products to which the phage is added in accordance with teachings of the present invention may be used as food.

In one aspect, the present invention includes the introduction of phage into the presence of edible agricultural products before or as they are ground, cut, or otherwise processed. Alternatively, phage-containing preparations may be mixed in with edible agricultural products that have been ground, cut, or otherwise processed after such processing.

According to another aspect, the present invention includes edible agricultural products that have been ground, cut, milled, or otherwise processed and that have been treated with phage. Phage is present not only on the outer surfaces of such agricultural products, but throughout the agricultural products. The phage may be substantially homogeneously dispersed, or distributed, throughout the ground, cut, or processed edible agricultural products (i.e., the phage or a preparation that includes the phage, may be present throughout a quantity of an edible agricultural product, or between adjacent bits or particles of the edible agricultural product).

The present invention, in another aspect, also includes methods for introducing phage-containing preparations into the interiors of solid edible agricultural products. As used herein, “solid edible agricultural products” includes edible agricultural products that are uncut and unprocessed, such as, but not limited to, cuts of meat, solid produce, and uncut, leafy produce. Some solid edible agricultural products, such as heads of lettuce, cabbage, and the like, may include surfaces that are somewhat internally confined and that define voids within the edible agricultural product. Other solid edible agricultural products, such as cuts of meat and many forms of produce, typically lack internally confined, void-defining surfaces. As an example of a method for introducing a phage-containing preparation into the interior of a solid edible agricultural product, the phage-containing preparation may be injected or infused into one or more locations within the interior of a piece of meat, a vegetable, or another solid edible agricultural product. A phage-containing preparation may be introduced into multiple locations within a solid edible agricultural product to disperse phage throughout the interior of the solid edible agricultural product. Depending upon the type of edible agricultural product, such processes may substantially homogeneously disperse phage throughout the interior of the solid edible agricultural product.

Accordingly, edible agricultural products, including processed agricultural products and solid agricultural products, with phage in the interiors thereof are also within the scope of the present invention. The phage within an edible agricultural product may be dispersed throughout a plurality of different interior locations. Such dispersal may, in some embodiments, be substantially homogeneous.

In some embodiments, the phage-containing preparation may be tailored to control bacterial populations in the edible agricultural product without completely eliminating the bacteria. Instead, the bioburden of bacteria, including pathogenic bacteria, within the edible agricultural products may merely be reduced. When the edible agricultural product is a food, control over bacterial levels will reduce the level of bacteria in the food to levels that are safe for consumption, while minimizing the amount of phage applied to the food. In other embodiments where the edible agricultural product is a food, the concentration or count of viable phage particles in the phage-containing preparation or in the processed edible agricultural product may be tailored to control bacterial populations in the gut following ingestion of the edible agricultural product.

Other features, advantages, and aspects of the inventive subject matter disclosed herein will become apparent to those of ordinary skill in the art through consideration of the ensuing description and the appended claims.

### DETAILED DESCRIPTION

Phage-containing preparations that are useful in various aspects of the present invention include lytic phage that specifically infects and destroys one or more types of unwanted bacteria, including, but not limited to, harmful, or pathogenic, bacteria, as well as non-pathogenic bacteria that may cause spoilage, decomposition, unpleasant odors or tastes, or the like, and bacteria that may interfere with desired processes, such as fermentation by yeast or bacteria. These types of unwanted organisms are referred to herein as “targeted bacteria.” Such lytic phage may include one or more types of phage with a broad host range, or “h-mutant” phage, which has been developed to infect wild-type strains of a targeted bacteria, as well as phage-resistant strains of the targeted bacteria. Examples of processes for developing h-mutant phage are disclosed in U.S. Patent Application Publication US 2006-0153811-A1 of Jackson, et al., dated Jul. 13, 2006, the entire disclosure of which is hereby incorporated herein by this reference. In addition to phage, phage-containing preparations may include growth media, carriers, and other substances that are useful in proliferating, processing, and/or storing phage.

The phage-containing preparation includes at least one type of phage that is specific for “targeted bacteria” that are present on or in a type of an edible agricultural product that is to be treated. Examples of disease-causing targeted bacteria against which the phage of a phage-containing preparation may be specific include, but are not limited to, one or more strains of bacteria within the shigatoxigenic group of Escherichia coli, one or more enterohemorrhagic strains of E. coli (e.g., O157:H7), one or more of the various species of the genus Salmonella, one or more of the various species of the genus Campylobacter, one or more of the various species of the genus Klebsiella, one or more of the various species of the genus Listeria, one or more of the various species of the genus Proteus, one or more of the various species of the genus Shigella, one or more of the various species of the genus Staphylococcus, one or more of the various species of the genus Streptococcus, one or more of the various species of the genus Vibrio, Clostridium perfringens, and Clostridium botulinum, which produces the nerve toxin botulin, which causes botulism. Examples of targeted bacteria that spoil or otherwise ruin (e.g., decompose, cause unpleasant odors or flavors in, etc.) edible agricultural products and against which the phage-containing preparation may be targeted include, without limitation, Clostridium botulinum, various species of the genus Staphylococcus, Bacillus cereus, and various species of the genus Listeria. As used herein, the term “phage” includes bacteriophage, as well as beneficial viruses that target other microorganisms, such as molds and yeasts, that are known to spoil edible agricultural products. Other types of bacteria against which the phage-containing preparation may be targeted include, but are not limited to, one or more of the various species of the genera Enterococcus and Pseudomonas.

A phage-containing preparation that is used in various aspects and embodiments of the present invention may be in the form of a solution or in dry form, such as that formed by freeze drying (or lyophilization), spray drying, or pulse combustion drying processes, as known in the art.

In one aspect, the present invention includes methods for processing edible agricultural products, in which the edible agricultural products are treated with a phage-containing preparation in conjunction with processing of the edible agricultural product. One embodiment of such a method includes treating, or disinfecting, edible agricultural products that have been ground, cut, or otherwise processed (e.g., ground meats, such as hamburger and other ground beefs, ground pork, ground turkey, and sausages; cut or ground produce; cut or milled grains; etc.) to control the population of bacteria therein. Such a method includes mixing phage, which may be part of a phage-containing preparation, with the ground, cut, or otherwise processed edible agricultural product. Phage may be mixed with the ground, cut, or otherwise processed edible agricultural product prior to, during or after grinding, cutting, or processing.

In some embodiments, a phage-containing preparation may be exteriorly applied to an edible agricultural product just prior to processing of the edible agricultural product. In other embodiments, a phage-containing preparation may be applied to processing surfaces of processing equipment (e.g., meat grinder, food processor, mill, etc.) just before processing. As the edible agricultural product is processed, the phage-containing preparation may be mixed into the edible agricultural product as it is processed; for example, as surfaces of the edible agricultural product that are formed or that otherwise become exposed during processing contact phage-containing preparation on other surfaces of the edible agricultural product or on processing surfaces of the processing equipment.

In an embodiment where phage is mixed with an edible agricultural product during grinding, cutting, or other processing, a phage-containing preparation may be applied to the exterior of the edible agricultural product or to the processing equipment during processing. Application of the phage-containing preparation to the processing equipment may be effected continuously throughout processing (e.g., through small channels in elements of the processing equipment that eject the phage-containing preparation from elements of the processing equipment, by applying the phage-containing preparation under pressure onto elements of the processing equipment, etc.).

In another embodiment where an edible agricultural product is mixed during grinding, a quantity (e.g., a volume of liquid, a liquid spray or mist, or powder) of a phage-containing preparation may be introduced into the processing equipment with a solid edible agricultural product that is to be ground, cut, or otherwise processed. As the edible agricultural product is processed, it is mixed with the phage-containing preparation.

Another embodiment of a method for applying a phage-containing preparation to ground, cut, or processed edible agricultural product includes applying the phage-containing preparation to the edible agricultural product as it leaves an apparatus that grinds, mills, or cuts the edible agricultural product into small bits or particles. As an example, a phage-containing solution may be sprayed onto ground meat as it is extruded from a grinder, or ground meat may be extruded into a mist of phage-containing solution. As another example, ground meat may be dusted with a dry, powdered phage-containing preparation as the meat is extruded from a meat grinder. The exposure of the ground, cut, or otherwise processed edible agricultural product occurs while surfaces of the small bits or particles of the edible agricultural product are exposed, and before further processing of the small bits or particles of the edible agricultural product, their collection into a quantity to be packaged, and their packaging.

Alternatively, a phage-containing preparation may be applied to quantities of an edible agricultural product that have already been ground, cut, or otherwise processed. In some embodiments of such a process, the phage-containing preparation (e.g., in liquid or solid form) may be mixed into the ground, cut, or otherwise processed edible agricultural product to form a slurry that includes the edible agricultural product and the phage-containing preparation. In other embodiments, a quantity of the ground, cut, or otherwise processed edible agricultural product may be soaked in a volume of phage-containing solution. In such embodiments, the phage-containing solution may diffuse between bits or particles of the edible agricultural product during the soaking processes. Once such a soaking process is complete (i.e., sufficient time has passed for the introduction of a desired amount of phage into the interior of the quantity of the edible agricultural product), excess liquid may be removed from the edible agricultural product by known techniques (e.g., by straining, by gravitational force, by pressing, by absorption, by negative pressure, by evaporation, etc.). In still other embodiments, a phage-containing preparation may be injected or infused into a quantity of ground, cut, or otherwise processed edible agricultural product.

When any of the foregoing processes, as well as any other, similar embodiment of phage application process, is employed, phage is introduced into the interior of a quantity of ground, cut, or otherwise processed edible agricultural product, as well as onto exterior surfaces of the quantity of the edible agricultural product. Such processes may disperse, or distribute, phage throughout a quantity of a ground, cut, or otherwise processed edible agricultural product. Such dispersal may be substantially homogenous. Dispersal of lytic phage throughout a quantity of an edible agricultural product is useful for preventing targeted bacteria from growing at any location on or within the quantity of the edible agricultural product.

The introduction of phage into the interior of a solid edible agricultural product may also be useful for controlling the growth of targeted bacteria within the edible agricultural product. Accordingly, another aspect of the present invention involves the introduction of phage into the interior of a solid edible agricultural product, including, without limitation, cuts of meat, solid produce, and uncut, leafy produce. As an example of a method for introducing a phage-containing preparation into the interior of a solid edible agricultural product, a liquid or solid phage-containing preparation may be injected or infused (e.g., by use of needles, by use of tubes, by jets that are configured to pierce an outer surface of the solid edible agricultural product, etc.) into one or more locations within the interior of a piece of meat, a vegetable, or another solid edible agricultural product. A phage-containing preparation may be introduced into multiple locations within a solid edible agricultural product to disperse phage throughout the interior of the solid edible agricultural product. Depending upon the type of edible agricultural product, such processes may substantially homogeneously disperse phage throughout the interior of the solid edible agricultural product. Such processes may be used alone or in combination with techniques that apply phage-containing preparations to outer surfaces of a solid edible agricultural product.

In some embodiments of various aspects of the present invention, the concentration of viable phage particles within the phage-containing preparation may be tailored, along with the amount of the phage-containing preparation that will ultimately be present within and, optionally, on the edible agricultural product (processed or solid), to control bacterial populations. In embodiments where the edible agricultural product may be used as a food, the concentration of phage in the phage-containing preparation that is applied to the food may be tailored to control bacterial populations in such a way that any remaining pathogenic bacteria or toxins produced thereby will remain safe for consumption by (i.e., not harm) consumers for a predetermined period of time (e.g., an acceptable shelf or storage life for a particular edible agricultural product). In some of these embodiments, the concentration of phage in a phage-containing composition and the amount of that phage-containing preparation within and, optionally, on a food may be tailored to maintain populations of targeted bacteria to counts that are safe for consumption, that will be safe in an animal's gut following consumption, or that may be further reduced to safe levels by properly cooking the food prior to consumption. When phage concentrations and the amounts of phage-containing compositions applied to food are controlled in this manner, excessive use of phage may be minimized. Additionally, effects of the addition of phage-containing preparations on the quality (e.g., aroma, flavor, consistency, etc.) of the food (e.g., a food into which a phage-containing preparation is internally introduced) may be minimized and, thus, the quality of the food may be sustained at a level that is acceptable to consumers, or substantially preserved. Stated another way, the concentration of phage in the phage-containing preparation and the amount of phage-containing preparation that is ultimately present within and, optionally, on the food may be tailored to avoid a noticeable or substantial diminishment in the quality of the food.

Although the foregoing description contains many specifics, these should not be construed as limiting the scope of the present invention, but merely as providing illustrations of some exemplary embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed:

1. A method for controlling bacterial populations in an edible agricultural product, comprising:
introducing a phage-containing preparation into an interior of a quantity of an edible agricultural product.

2. The method of claim 1, wherein introducing comprises introducing the phage-containing preparation onto an edible agricultural product that has been ground, cut, or otherwise processed for subsequent collection into the quantity and packaging.

3. The method of claim 2, wherein introducing comprises applying the phage-containing preparation onto surfaces of bits or particles of the edible agricultural product while grinding, cutting, or processing the edible agricultural product.

4. The method of claim 3, wherein applying comprises mixing the phage-containing preparation into bits or particles of the edible agricultural product while grinding, cutting, or processing the edible agricultural product.

5. The method of claim 2, wherein introducing comprises applying the phage-containing preparation to the edible agricultural product as it exits apparatus for grinding, cutting, or processing the edible agricultural product.

6. The method of claim 2, further comprising:
collecting the edible agricultural product into the quantity,
wherein introducing comprises applying the phage-containing preparation to bits or particles of the edible agricultural product in the quantity.

7. The method of claim 1, wherein introducing comprises introducing the phage-containing preparation into the interior of a solid edible agricultural product.

8. The method of claim 1, further comprising:
tailoring a concentration of phage in the phage-containing preparation; and
tailoring an amount of the phage-containing preparation to be applied within the quantity of the edible agricultural product.

9. The method of claim 8, wherein the concentration and amount are tailored to maintain a population of at least one type of bacteria at levels that are safe for consumption.

10. The method of claim 8, wherein the concentration and the amount are tailored to substantially preserve a quality of the edible agricultural product.

11. The method of claim 8, wherein the concentration and the amount are tailored to control the growth of the targeted bacteria after it has been ingested or otherwise introduced within the gut of animals or humans.

12. The method of claim 1, further comprising:
applying a phage-containing preparation to at least one of an outer surface of the quantity of the edible agricultural product and a surface of processing equipment; and
grinding, cutting, or otherwise processing the edible agricultural product to introduce phage on the outer surface of the quantity of the edible agricultural product or on the surface of the processing equipment into an interior of a processed quantity of the edible agricultural product.

13. An edible agricultural product, comprising:
a quantity of an edible agricultural product; and
a phage-containing preparation within the quantity of the edible agricultural product.

14. The edible agricultural product of claim 13, wherein the phage-containing preparation is dispersed throughout the quantity of the edible agricultural product.

15. The edible agricultural product of claim 14, wherein the phage-containing preparation is substantially homogeneously dispersed throughout the quantity of the edible agricultural product.

16. The edible agricultural product of claim 13, further comprising phage-containing preparation on an outer surface of the quantity of the edible agricultural product.

17. The edible agricultural product of claim 13, wherein the quantity of the edible agricultural product comprises a quantity of a solid edible agricultural product.

18. The edible agricultural product of claim 17, wherein the quantity of solid edible agricultural product lacks internally confined surfaces and voids defined by the internally confined surfaces.

19. The edible agricultural product of claim 13, wherein the quantity of the edible agricultural product comprises a plurality of bits or particles of the edible agricultural product that have been collected to form the quantity.

20. The edible agricultural product of claim 19, wherein the quantity of the edible agricultural product comprises ground meat.

21. The edible agricultural product of claim 13, wherein a concentration of phage in the phage-containing preparation and an amount of the phage-containing preparation present within the quantity of the edible agricultural product are tailored to maintain a population of levels that are safe for consumption while substantially preserving a quality of the edible agricultural product.
